(19) United States
(12) Patent Application Publication
(10) Pub. No.: US 2009/0327880 A1
(43) Pub. Date: Dec. 31, 2009

(54) TEXT INPUT

(75) Inventor: Masahiko Ide, Lempaala (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/164,673

(22) Filed: Jun. 30, 2008

(51) Int. Cl. G06F 17/24

(52) U.S. Cl. 715/261

(57) ABSTRACT

A mobile communications device including a receiver for receiving metadata; a memory for storing the received metadata; a user interface for receiving user input defining a first string of characters; a controller for searching the metadata for the first string of characters by traversing the received metadata and extracting at least one second string of characters, wherein the at least one second string of characters is embedded in the metadata and wherein a first part of the at least one second string of characters matches the first string of characters; wherein the user interface is configured to display the at least one second string of characters for selection; and wherein the controller is arranged to instruct the memory to, in a case one of the at least one second string is selected, store the at least one second string in a first predictive text dictionary.

### TECHCNICAL FIELD

The disclosed embodiments relate to the field of mobile communications devices, and more particularly to receiving metadata and extracting information from the metadata in mobile communications devices.

### BACKGROUND

Mobile communications devices, e.g. mobile (cellular) telephones, for mobile telecommunication systems like GSM, UMTS, D-AMPS and CDMA2000 have been used for many years.

Mobile communications devices, such as mobile phones or personal digital assistants (PDAs), are today used for many different purposes. Typically, displays are used for output and keypads are used for input, particularly in the case of mobile communications devices. Mobile communications devices were previously used almost exclusively for voice communication with other mobile communications devices or stationary telephones. Gradually, the use of mobile communications devices has been broadened to include not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc.

For large devices, such as personal computers or laptop computers, large screens and more refined input mechanisms allow for a rich and intuitive user interface. At the same time, there has been a trend towards ever-increasing reduction of the size of mobile communications devices. One issue with user interfaces for small portable electronic devices, such as mobile communications devices, is that reduction of size may lead to difficulties for entering data into the device. Displays may be small and user input may be limited. Any improvement in the user experience of such devices have an impact on usability and attractiveness.

It is commonplace to provide mobile communications devices with various systems for facilitating input of objects, such as graphical characters. One system commonly used with mobile telephones is to let each numerical key of a keypad of the mobile telephone represent up to four characters, which enables the user to input a certain character by depressing the appropriate key a certain number of times corresponding to the desired character. Other mobile communications devices provide, on a touch-sensitive screen, a virtual alphanumeric keyboard for character input. The user can then select from virtual alphanumeric keyboard, often using a stylus, which character to input.

Predictive text editing programs, engines, or functionalities have been developed which make use of a dictionary of complete words stored in a memory of the mobile communications device. The dictionary provides the text editing program with additional information to complement the key presses entered on the keypad. By using this information intelligently, such as comparing the key presses with pre-stored candidate words, the text editing program can help the user input the desired word with less keystrokes than non-predictive text editing programs thus making the text entry less time consuming and more user friendly.

An example of a predictive text editing program is the T9™ disambiguation software found in many mobile communications devices. This software is described in detail e.g. in the U.S. Pat. No. 5,818,437, assigned to Tegic Communication Inc. of Seattle, Wash., USA. When entering a word using the software, the user operates each key only once rather than scrolling through the individual characters associated with the key. Thus each key operation has an associated ambiguity due to the fact that a number of (different) characters are associated with the key. Accordingly the key sequences produced by actuating key corresponding to a word only once has an associated ambiguity because the sequence could represent more than one word. In order to resolve the ambiguity of this inherently ambiguous key sequence, a word or words corresponding to the ambiguous key sequence are stored in the memory and displayed to the user so that selection can be made. This procedure greatly reduces the number of key strokes required to enter text.

Disambiguation is carried out by reference to a pre-programmed dictionary of words associated with the individual ambiguous key sequences. Due to memory restriction the dictionary cannot contain every possible word that may want to be entered by the user.

### SUMMARY

Text entry techniques have often been found to be laborious, time consuming and not particularly user friendly because of the multiple use of keys needed to enter a word in text input applications. It would be advantageous to have an improved user interface that can be associated with small portable electronic devices having limited resource for receiving user input.

Also, prior techniques do not provide support for associating metadata objects with text input applications. In view of the above, it would be advantageous to have an alternative method for text input.

Hence according to a first aspect there is provided a mobile communications device, comprising a receiver for receiving metadata; a memory for storing the received metadata; a user interface for receiving user input defining a first string of characters; a controller for searching the metadata for the first string of characters by traversing the received metadata and extracting at least one second string of characters, wherein the at least one second string of characters is embedded in the metadata and wherein a first part of the at least one second string of characters matches the first string of characters; wherein the user interface is arranged to display the at least one second string of characters for selection; and wherein the controller is arranged to instruct the memory to, in a case one of said at least one second string is selected, store the at least one second string in a first predictive text dictionary.

Thus the disclosed subject-matter provides for extracting information objects, such as text and image components from complex data structures. The disclosed subject-matter further provides for associating the extracted information objects with a dictionary for predictive text. Thus the disclosed subject-matter provides an improved mobile communications device. In particular a mobile communications device with an improved user interfaces is provided.

The disclosed subject-matter enables more efficient input associated with less unrecognized or irrelevant words to be achieved. The disclosed subject-matter enables the communication of a user to be facilitated by contemplation of the output word flow and enables enhancement of the input text. The disclosed subject-matter enables the presented words to be more appropriate because the device usage becomes integrated and reflected by the extracted text information.

The user interface, when in operation, may be arranged to display the metadata; and the controller may be arranged to instruct the user interface to, in a case a first part of the at least one second string of characters matches the first string of characters, highlight the first string of characters in the metadata on the user interface.

Thus such a user interface provides for improved navigation on a display screen of a mobile communications device. It also provides for improved user experience.

The memory may further comprise a second predictive text dictionary; and the controller may be arranged for searching said second predictive text dictionary for said first string of characters.

The second predictive text dictionary may be at least part of a standard predictive text dictionary, such as, but not limited to, the predictive text dictionary associated with the T9™ text disambiguation software. Thus the functions of the disclosed subject-matter may be combined with other software components.

The controller may be arranged to instruct the user interface to, in a case a first part of at least one third string of characters matches the first string of characters, display the at least one second string of characters and the at least one third string of characters for selection, wherein the at least one third string of characters is comprised in the second predictive text dictionary.

The controller may search the metadata for the first string of characters only in a case the first string of characters is not found in the second predictive text dictionary.

Thus computational requirements for searching the metadata is minimized.

The controller may be arranged to extract all unique strings of characters in the metadata and to instruct the memory to store in the first predictive text dictionary only those unique strings of characters which are not comprised in the second predictive text dictionary.

The mobile communications device may thus be arranged not to save extracted information objects, such as strings of characters if the extracted information is already comprised in a second dictionary. Thus memory requirements for the first predictive text dictionary are saved. Thus the overall memory requirements for allowing metadata components are minimized.

The memory may store the received metadata during a first time period; and the memory may store the unique strings of characters during a second time period.

It may thus be determined to store, or save, metadata and the unique strings of characters during the same or different time periods.

The second time period may be longer than the first time period. Thus the extracted information objects, such as the extracted strings of characters may be stored even after the application with which the metadata is associated is closed. The extracted information objects may thus be available whether or not the mobile communications device is operatively connected to a communications network.

The user interface may comprises a web browser arranged to display a webpage and the metadata may be comprised in the webpage.

Thus the disclosed subject-matter allows for extracting information objects from complex data structures, such as images and/or webpages and the like. Thus the disclosed subject-matter allows for associating metadata with extracted information objects, wherein the metadata is associated with complex data structures, such as images and/or webpages.

The metadata may comprise at least one image and the at least one second string of characters may be embedded in the at least one image.

Thus the disclosed subject-matter allows for extracting information objects from images, wherein the images may be associated with webpages and the like.

The user interface may comprise a plurality of input keys, wherein each input key of the plurality of input keys may be associated with a plurality of input characters; the first string of characters may be associated with an ambiguous text input formed by at least one input key press of the plurality of input keys; and the matching may comprise comparing character combinations associated with the ambiguous text input with the first part of the at least one second string of characters.

Thus the disclosed subject-matter provides an improved text disambiguation functionality.

According to a second aspect there is provided a method in a mobile communications device, wherein the method comprises receiving metadata; storing the received metadata; receiving user input defining a first string of characters; searching the metadata for the first string of characters by traversing the received metadata and extracting at least one second string of characters, wherein the at least one second string of characters is embedded in the metadata and a first part of the at least one second string of characters matches the first string of characters; displaying the at least one second string of characters for selection; and wherein in a case one of the at least one second string of characters is selected, storing the at least one second string of characters in a first predictive text dictionary.

The method may further comprise displaying the metadata; and in a case a first part of the at least one second string of characters matches the first string of characters, the first string of characters may be highlighted in the metadata.

A second predictive text dictionary may be searched for the first string of characters.

In a case a first part of at least one third string of characters matches the first string of characters, the method may further comprise displaying the at least one second string of characters and the at least one third string of characters for selection, wherein the at least one third string of characters may be comprised in the second predictive text dictionary.

The metadata may be searched for the first string of characters only in a case the first string of characters is not found in the second predictive text dictionary.

All, or almost all, unique strings of characters in the metadata may be extracted; and only those unique strings of characters which are not comprised in the second predictive text dictionary may be stored.

The received metadata may be stored during a first time period; and the unique strings of characters may be stored during a second time period.

The second time period may be longer than the first time period.

The method may further comprise displaying a webpage and the metadata may be comprised in the webpage.

The metadata may comprise at least one image and the at least one second string of characters may be embedded in the at least one image.

The first string of characters may be associated with an ambiguous text input formed by at least one input key press of a plurality of input keys, wherein each input key of the plurality of input keys may be associated with a plurality of input characters; and the matching may comprise comparing character combinations associated with the ambiguous text input with the first part of the at least one second string of characters.

According to a third aspect there is provided a computer program stored on a computer-readable storage medium, which when executed on a processor of a mobile communications device performs the a method according to the second aspect.

According to a fourth aspect there is provided a user interface of a mobile communications device, wherein the user interface is arranged for displaying metadata; receiving user input defining a first string of characters; receiving at least one second string of characters, wherein the second string of characters is embedded in the metadata; receiving instructions to, in a case a first part of the at least one second string of characters matches the first string of characters, highlight the first string of characters in the metadata on the display; displaying the at least one second string of characters for selection; receiving user input pertaining to selecting one of the at least one second string of characters; and communicating the selecting of the selected one of the at least one second string of characters to a controller.

The first string of characters may be associated with an ambiguous text input formed by at least one input key press of a plurality of input keys, wherein each input key of the plurality of input keys may be associated with a plurality of input characters; and the matching may comprise comparing character combinations associated with the ambiguous text input with the first part of the at least one second string of characters.

The user interface may be configured to display a webpage; and the metadata may be comprised in the webpage.

The metadata may comprise at least one image and the at least one second string of characters may be embedded in the at least one image.

According to a fifth aspect there is provided a mobile communications device, comprising a receiver for receiving metadata in a first format, wherein the metadata is associated with a first application; a first memory for storing the metadata; a controller using a second application for extracting information components from the stored metadata to a second format different from the first format; a second memory for storing at least one of the extracted information components; and wherein the controller is configured for providing at least one of the at least one of the extracted information components to a third application.

The third application may be different from the first application.

The first application may comprise displaying a webpage; the information components may be text components; and the third application may be associated with text input.

The metadata may be stored in the first memory during a first time period; the at least one of the extracted information components may be stored in the second memory during a second time period; and the second time period may be longer than the first time period.

According to a sixth aspect there is provided a method in a mobile communications device, wherein the method comprises receiving metadata in a first format, wherein the metadata is associated with a first application; storing the metadata in a first memory; extracting information components from the stored metadata to a second format different from the first format using a second application; storing at least one of the extracted information components in a second memory; and providing at least one of the at least one of the extracted information components to a third application.

According to a seventh aspect there is provided computer program stored on a computer-readable storage medium, which when executed on a processor of a mobile communications device performs a method according to the sixth aspect.

The second, third, fourth, fifth, sixth and seventh aspects may generally have the same features and advantages as the first aspect

Some of the embodiments provide for a novel and alternative way of entering objects, such as text characters and images, into a mobile communications device by first extracting text components and image components from metadata. Furthermore, it is an advantage with some embodiments that they provide a user-friendly and intuitive way of entering objects into the mobile communications device.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects of the disclosed embodiments will now be described in more detail, reference being made to the enclosed drawings, in which:

FIG. 1 is a schematic illustration of a cellular telecommunication system, as an example of an environment in which the aspects of the disclosed embodiments may be applied;

FIG. 2 is a schematic front view illustrating a mobile communications device according to an embodiment;

FIG. 3 is a schematic block diagram representing an internal component, software and protocol structure of a mobile communications device according to an embodiment;

FIG. 4 illustrates a sequence of display views of a mobile communications device according to an embodiment;

FIG. 5a is a schematic display view of a mobile communications device according to an embodiment;

FIG. 5b is a schematic display view of a mobile communications device according to an embodiment;

FIG. 6 is an illustration of different file formats according to an embodiment;

FIG. 7 is a flowchart for a method in a mobile communications device; and

FIG. 8 is a flowchart for a method in a mobile communications device.

### DETAILED DESCRIPTION OF EMBODIMENTS

The disclosed embodiments will now be described more fully hereinafter with reference to the accompanying drawings, in which certain embodiments are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

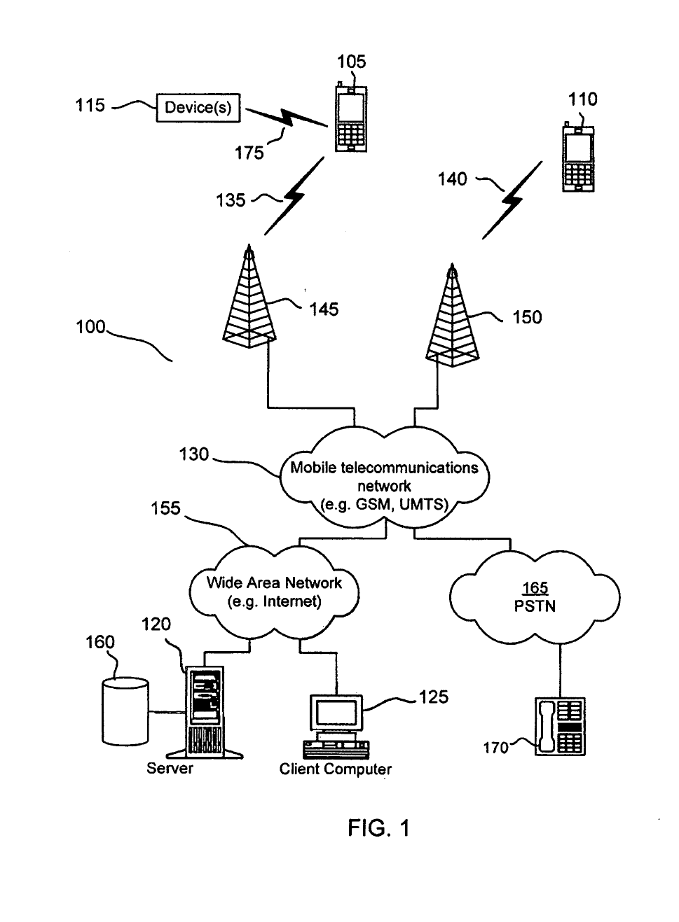

FIG. 1 illustrates an example of a cellular telecommunication system 100 in which the invention may be applied. In the telecommunication system 100 of FIG. 1, various telecommunication services such as cellular voice calls, www/wap browsing, cellular video calls, data calls, facsimile transmissions, music transmissions, still image transmissions, video transmissions, electronic message transmissions, electronic positioning information, and electronic commerce may be performed between a mobile communications device 105 and other devices, such as another mobile communications device 110, a local device 115, a computer 120, 125 or a stationary telephone 170. It is to be noted that for different embodiments of the mobile communications device 105 and in different situations, different ones of the telecommunication services referred to above may or may not be available; the invention is not limited to any particular set of services in this respect.

The mobile communications devices 105, 110 may be operatively connected to a mobile telecommunication network 130 through RF links 135, 140 via base stations 145, 150. The base stations 145, 150 may be operatively connected to the mobile telecommunication network 130. The mobile telecommunication network 130 may be in compliance with any commercially available mobile telecommunication standard, such as GSM, UMTS, D-AMPS, CDMA2000, FOMA and TD-SCDMA.

The mobile telecommunication network 130 may be operatively connected to a wide area network 155, which may be Internet or a part thereof. An Internet server 120 may have a data storage 160 and may be operatively connected to the wide area network 155, as is an Internet client computer 125. The server 120 may host a www/wap server capable of serving www/wap content to the mobile communications devices 105, 110.

A public switched telephone network (PSTN) 165 may be operatively connected to the mobile telecommunication network 130 in a familiar manner. Various telephone terminals, including the stationary telephone 170, may be operatively connected to the PSTN 165.

The mobile communications device 105 may also be capable of communicating locally via a local link 175 to one or more local devices 115. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, and communication aided by the infrared data association (IrDA) standard, etc.

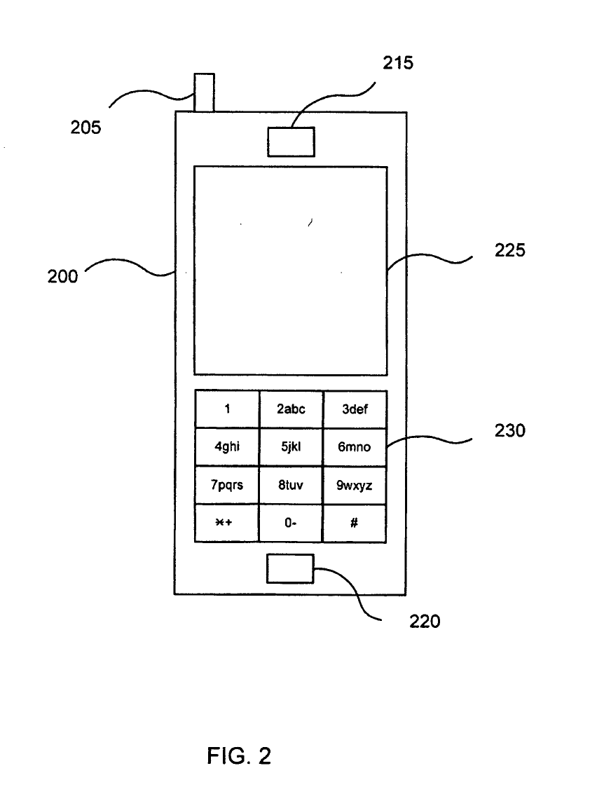

An embodiment 200 of the mobile communications device 105 is illustrated in more detail in FIG. 2. The mobile communications device 200 may comprise an antenna 205, a camera 210, a speaker or earphone 215, a microphone 220, a display 225 (e.g. a touch sensitive display) and a set of keys which may include a keypad 230 of common ITU-T type (alpha-numerical keypad representing characters “0”-“9”, “*” and “#”) and certain other keys such as soft keys, and a joystick or other type of navigational input device, including input devices specifically designed to facilitate easy scrolling of display content. Such a user input device may be a rotational input device or a touch sensitive device on which a user applies pressure along a path etc. The mobile communications device 200 may be e.g. a mobile phone, a personal digital assistant (PDA), a portable media player, or the like.

As shown in FIG. 2 some of the keys for the keypad 230 may be associated with both numbers and alphanumeric characters. For convenient reference, the individual keys will be identified by their number, e.g. the key marked with the number 3 will be referred to as the “3-key”. Thus the 4-key is associated with the number “4” but also the letters “g”, “h”, and “i”. An individual one of the associated letters may be selected by successive operations of the 4-key. For example, if the letter “i” is to be selected, on the first operation, e.g. by receiving user input in the form of a depression or selection action, of the 4-key, the letter “g” is commonly displayed, the second operation displays “h” and the third operation displays “i”. A further operation displays “4”. It will be understood that by this approach, the limited number of keys of the keypad can be used to select all the letters of the alphabet and other characters for conventional punctuation.

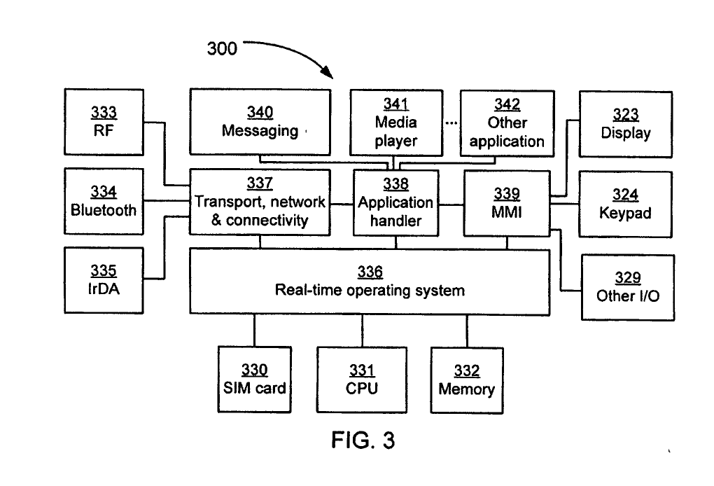

The internal components 300, software and protocol structures of the mobile communications device 105, 200 will now be described with reference to FIG. 3. The mobile communications device may have a controller 331 which is responsible for the overall operation of the mobile communications device and is preferably implemented by any commercially available CPU (Central Processing Unit), DSP (Digital Signal Processor) or any other electronic programmable logic device. The controller 331 may have associated electronic memory 332 such as RAM memory, ROM memory, EEPROM memory, flash memory, or any combination thereof. The memory 332 may be used for various purposes by the controller 331, one of them being for storing data and program instructions for various software in the mobile communications device. The memory 332 may further store one or more dictionaries comprising words. The memory 332 may further store a plurality of metadata objects, such as video clips, picture clips, audio clips, text clips, and so on.

The software may include a real-time operating system 336, drivers for a man-machine interface (MMI) 339, an application handler 338 as well as various applications. The applications can include a messaging application 340 for sending and receiving SMS, MMS or email, a media player application 341, as well as various other applications 342, such as applications for voice calling, video calling, web browsing, an instant messaging application, a phone book application, a calendar application, a control panel application, a camera application, one or more video games, a notepad application, a positioning application, an information extracting application, etc.

The MMI 339 may also include one or more hardware controllers, which together with the MMI drivers cooperate with the display 323, 225, keypad 324, 230, as well as various other I/O devices 329 such as microphone 220, speaker 215, vibrator, ringtone generator, LED indicator, etc. As is commonly known, the user may operate the mobile communications device through the man-machine interface thus formed.

The software may also include various modules, protocol stacks, drivers, etc., which are commonly designated as 337 and which provide a transmitter and a receiver for communication services (such as transport, network and connectivity) for an RF interface 333, and optionally a Bluetooth interface 334 and/or an IrDA interface 335 for local connectivity.

The RF interface 333 may comprise an internal or external antenna as well as appropriate radio circuitry for establishing and maintaining a wireless link to a base station (e.g. the link 135 and base station 145 in FIG. 1). As is well known to a person skilled in the art, the radio circuitry may comprise a series of analogue and digital electronic components, together forming a radio receiver and transmitter. These components may include, e.g., band pass filters, amplifiers, mixers, local oscillators, low pass filters, AD/DA converters, etc.

The mobile communications device 105, 200 as represented by the internal components 300 in FIG. 3 may also have a SIM card 330 and an associated reader. As is commonly known, the SIM card 330 may comprise a processor as well as local work and data memory.

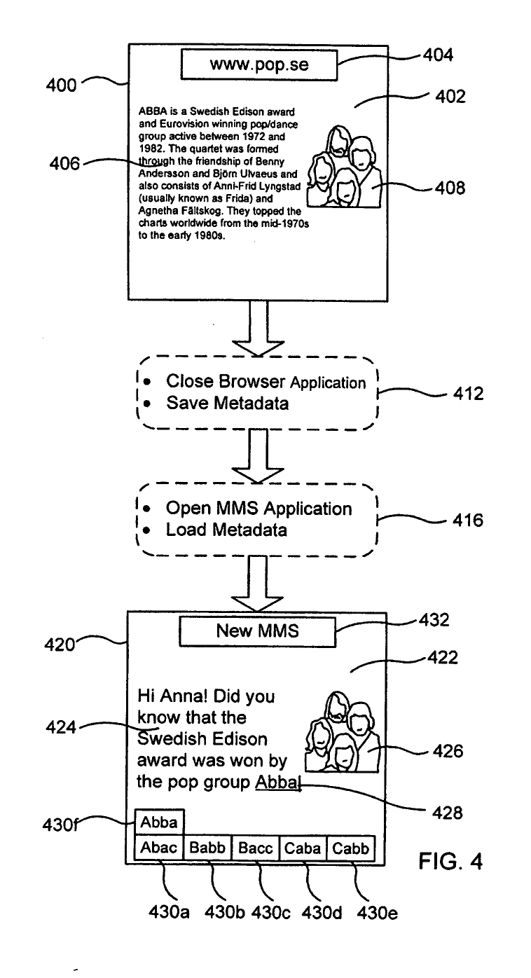

Continuing now with FIG. 4 which illustrates a schematic display view of a display 400, such as the display 225 of the mobile communications device 105, 200 of FIGS. 1 and 2. The display 400 is arranged to display a plurality of metadata objects, commonly denoted by the reference numeral 402. The metadata may comprise a plurality of embedded text objects 406. The metadata may comprise a plurality of picture or image objects 408. The metadata may e.g. represent an internet webpage, a wap page or the like.

In the illustrative example of FIG. 4a the display 400 further displays a metadata identifier 404 identifying the source of the displayed metadata. For example, if the metadata represents an internet webpage the metadata identifier 404 may represent a universal resource locator (URL) associated with the webpage.

The metadata may thus be represented by the HTML format, the XML format, Flash, Java, JPEG, GIF, and the like.

In the illustrative example of FIG. 4a the plurality of metadata objects 402 comprises at least one embedded text object denoted by the reference numeral 406 and at least one embedded image object denoted by the reference numeral 408. However, without losing generality the plurality of metadata objects 402 may comprise only one or more embedded text objects 406 or one or more embedded image objects 408.

Thus in general terms the display 400 may be said to display metadata objects 402, 406, 408 in one or more first formats, such as HTML or JPEG by running a first application, such as a web browser application. Hence there is proposed a method comprising receiving metadata 402, 406, 408 in a first format, wherein the metadata 402, 406, 408 is associated with a first application.

Whilst running the first application the received metadata 402 or the metadata objects 406, 408 are stored in a memory of the mobile communications device 105, 200. The metadata objects 406, 408 may be stored temporarily. Hence the method may comprise storing the metadata 402, 406, 408 in a first memory.

When the first application, in this example the web browser application, is closed by the user, as illustrated in a step 412, the metadata 402, 406, 408 is according to related art erased from the memory. However it has been observed by the inventors that it may be beneficial to store at least some of the metadata 402, 406, 408 for future use. In order to facilitate efficient storage of the metadata objects 402, 406, 408 information components such as text components and image components are extracted from the stored metadata before the metadata 402 may be erased. The text components may prior to receiving the metadata 402 not have been stored in a memory of the mobile communications device. The memory is advantageously associated with a predictive text dictionary. The extracted image components may be images, which prior to receiving the metadata 402, have not been stored in a memory of the mobile communications device. Since the text components and/or the image components have been extracted from the metadata 402 the text components and the image components are associated with second data formats; typically the text components are associated with one format and the image components are associated with another format. The extraction process may be executed by a second application different from the first application. Hence the method may further comprise extracting information components from said stored metadata to a second format different from said first format using a second application. Hence the method may further comprise storing at least one of the extracted information components in a second memory. That is, a browser application may process the metadata 402 and generate a temporary dictionary for use by a disambiguate engine which may be part of the software of the mobile communications device 100, 200, 300.

A third application, such as a composer application may then be opened, as illustrated in a step 416. Typically such a composer application may involve composing an Email, an SMS, a MMS, a blog item, or the like. The stored information components, such as the extracted text components or image components may then be made available for the third application. That is, the text components may e.g. be made available through a dictionary for predictive text input, such that when a user input key sequences on the keypad of the mobile communications device matching text sequences are searched for in the dictionary. Hence the method may further comprise providing at least one of said at least one of said extracted information components to a third application.

The display view 420 schematically illustrates a message composing view, wherein the message inter alla may be an Email, an SMS, a blog item, or the like. As illustrated by the message composer identifier 432 the message in the example of the display view 420 is an MMS. The message composing view comprises a composed message 422 which may have a text component 424 and/or one or more image components 426. The cursor identifier 428 illustrates a current position in the composed message. As illustrated by the predictive text match items 430a-430e a standard T9™ dictionary would include the words “Abac”, “Babb”, “Bacc”, “Caba” and “Cabb”. However, the standard T9™ dictionary does not include the desired word to be inputted, namely “Abba”. However, in this example, since the word “Abba” has been stored from the metadata displayed in the display view 400, the word “Abba” now appears as a predictive text match item 430f. Also the image component 426 may easily be included, e .g. by an “insert object” menu, since the same image component appeared as a metadata image component 408 in the metadata 402 as displayed in the display view 400, when running the first application, i.e. the browser application.

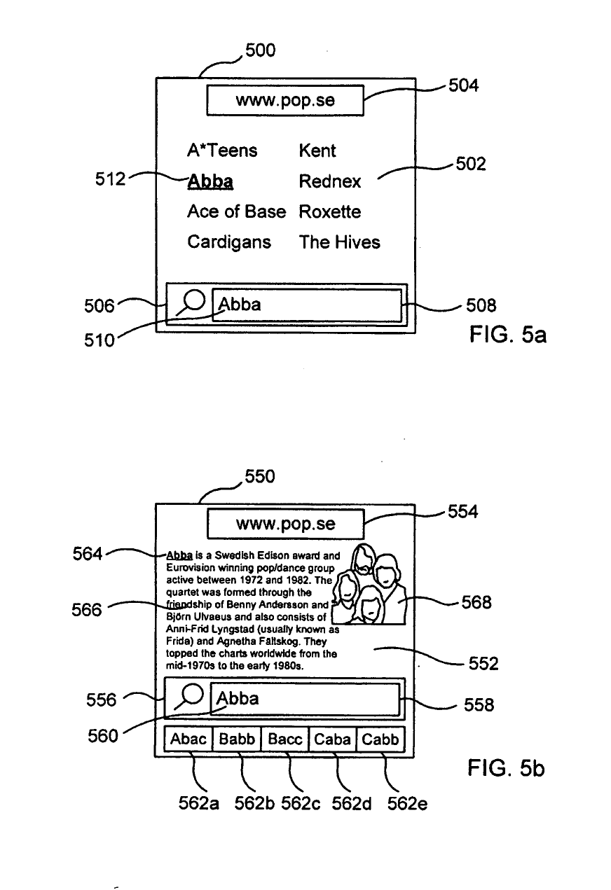

FIG. 5a is a schematic display view of a display 500, such as a display view of the display 225 of the mobile communications device 105, 200 of FIGS. 1 and 2 and similar to the display view 400 of FIG. 4. The display view 500 is thus arranged to display a plurality of metadata objects, commonly denoted by the reference numeral 502. The metadata may comprise a plurality of embedded text objects and picture objects and may e.g. represent an internet webpage, a wap page or the like.

In the illustrative example of FIG. 5a the display 500 further displays a metadata identifier 504 which may represent a universal resource locator (URL) associated with the webpage.

The display 500 may further comprise a search window 506 for searching the displayed metadata 502. In the illustrative example of FIG. 5a the search window 506 comprises a text input window 508 arranged for receiving user input in the form of a first string of characters 510. The first string of characters may be created from receiving a sequence of keystrokes from the keypad 230. The keystrokes may represent ambiguous text input formed by at least one input key press of the plurality of input keys of the keypad 230.

Alternatively, if the display 500 comprises a touch sensitive screen the first string of characters 510 may be created from detecting one or more penstrokes from the touch sensitive screen, which one or more penstrokes are interpreted, by using any conventional method for text recognition, as a sequence of characters.

In the example of FIG. 5a the metadata 502 of the display 500 represent an Internet search result for Swedish pop groups. For example, the Internet search finds the pop groups “A*Teens”, “Abba”, “Ace of Base”, “Cardigans”, “Kent”, “Rednex”, “Roxette” and “The Hives”. As a first string of characters 510 is received the metadata 502 is searched for a matching string of characters. A matching string of characters is here defined as a second string of characters wherein a first part of the second string of characters is identical to the first string of characters 510. In the illustrative example of FIG. 5a the first string of characters 510 represents the word “Abba”. A search functionality then searches the metadata 502 in order to find a matching string of characters.

The metadata 502 may e.g. be searched by extracting text components and image components from the metadata 502. If one or more matching strings of characters is/are found in the metadata 502, the one or more matching strings of characters and/or whole word(s) associated with the one or more matching strings of characters in the metadata 502 can be highlighted in the display view 500, as indicated by the highlighted metadata item 512. The highlighting may be accomplished by displaying the item to be highlighted in e.g. with a color, size, shape, or background which is different from the non-highlighted items. If a highlighted item 512 is selected, e.g. by a user pressing a key on the keypad 230, the sequence of characters corresponding to the highlighted and selected item 512 may be stored in a memory of the mobile communications device 105, 200. For example, the memory in which the highlighted and selected item 512 is stored in may be associated with a dictionary. This dictionary may be utilized by a predictive text input engine.

Alternatively, all extracted components, such as text and images, not found in a memory of the mobile communications device may be stored. Before being stored the extracted text components may be compared with text components in a dictionary associated with predictive text input and only those text components which are not found in the dictionary are stored.

That is, the text components may e.g. be stored in a first predictive text dictionary. The standard T9™ dictionary may be associated with a second predictive text dictionary. Alternatively the first predictive text dictionary and the second predictive text dictionary may be parts of the same predictive text dictionary.

FIG. 5b is a schematic display view of a display 550, such as the display 225 of the mobile communications device 105, 200 of FIGS. 1 and 2 and similar to the display view 500 of FIG. 5a. The display 550 is arranged to display a plurality of metadata objects, commonly denoted by the reference numeral 552. The metadata may comprise a plurality of embedded text objects 566 and picture objects 568 and may e.g. represent an internet webpage, a wap page or the like.

In the illustrative example of FIG. 5b the display 550 further displays a metadata identifier 554. For example, if the metadata represents an internet webpage the metadata identifier 554 may represent a universal resource locator (URL) associated with the webpage.

The display 550 may further comprise a search window 556 for searching the displayed metadata 552. In the illustrative example of FIG. 5b the search window 556 comprises a text input window 558 arranged for receiving user input in the form of a first string of characters 560.

As a first string of characters 560 is received the metadata 552 is searched for a matching string of characters. A matching string of characters is here defined as a second string of characters wherein a first part of the second string of characters is identical to the first string of characters 560.

If the first string of characters 560 represent ambiguous text input the metadata 552 is searched for candidate strings of characters which may disambiguate the ambiguous text input. That is, the candidate strings of characters correspond to text input which may be formed by pressing or stroking the same sequence of keys as for the ambiguous text input.

For example the user may enter an ambiguous key sequence, comprising a sequence of individual key operations. For each key operation in the ambiguous sequence, the key marked with the group of letters comprising the desired letter is operated only once. Individual ambiguous key sequences are stored in a predictive text dictionary of the memory, wherein each key sequence is associated with words or like text items corresponding to the sequence. Since the key sequence is inherently ambiguous, more than one word corresponding to the sequence may be stored in the predictive text dictionary and the user may be given an option to select one of the words. For example, with reference to the keypad 230 of the mobile communications device 200 of FIG. 2, successive operation of the keys “4”, “6”, “6”, “3” could correspond to the entry of the word “home” or “good”. The ambiguous key sequence “4”, “6”, “6”, “3” is however according to the T9™ dictionary associated in the dictionary of the memory inter alla with the text items “home”, “good”, “gone” and “hood”, so that when said ambiguous key sequence is entered by the user, the words “home”, “good”, “gone” and “hood” are displayed on the display 225, 500 and the user can then make a selection. For some key sequences, there will be only one item of text associated with it, in which case the user does not need to make an explicit selection.

In case of one matching word only or in case of the highlighted word being the correct word, user selection may be performed by inputting the space character, by pressing an “ok” button or pressing another non-character button to acknowledge. Thus selection may be performed when an inputted word is accepted either directly with user confirmation or indirectly by user inputting other input than characters.

In the illustrative example of FIG. 5b a plurality of candidate strings of characters 562a-562e are also displayed. The plurality of candidate strings of characters 562a-562e correspond to text input which may be formed by pressing or striking the same sequence of keys as for the ambiguous text input. The plurality of candidate strings of characters 562a-562e may represent candidate words found by a predictive text input engine, such as the T9 predictive text input engine.

For the ambiguous key sequence “2”, “2”, “2”, “2” the standard T9™ dictionary would provide only the matches “Abac”, “Babb”, “Bacc”, “Caba” and “Cabb”, as indicated by the candidate strings of characters 562a-562e. The word “Abba”, which is also associated with the ambiguous key sequence “2”, “2”, “2”, “2” is thus not found in the dictionary. However, the word “Abba” is comprised as one of the text components 566 in the metadata 552. Thus by extracting all text and/or image components from the metadata 552 the text string “Abba” may be identified. The text string “Abba” may further be stored in a predictive text input engine, which may be different from, or an addition to, the standard T9™ dictionary. By receiving the ambiguous key sequence “2”, “2”, “2”, “2” the disambiguation engine may thus associate the received ambiguous key sequence with the text string “Abba” and provide “Abba” as a suggestion for selection. The identified text string may further be highlighted, as illustrated by the reference numeral 564.

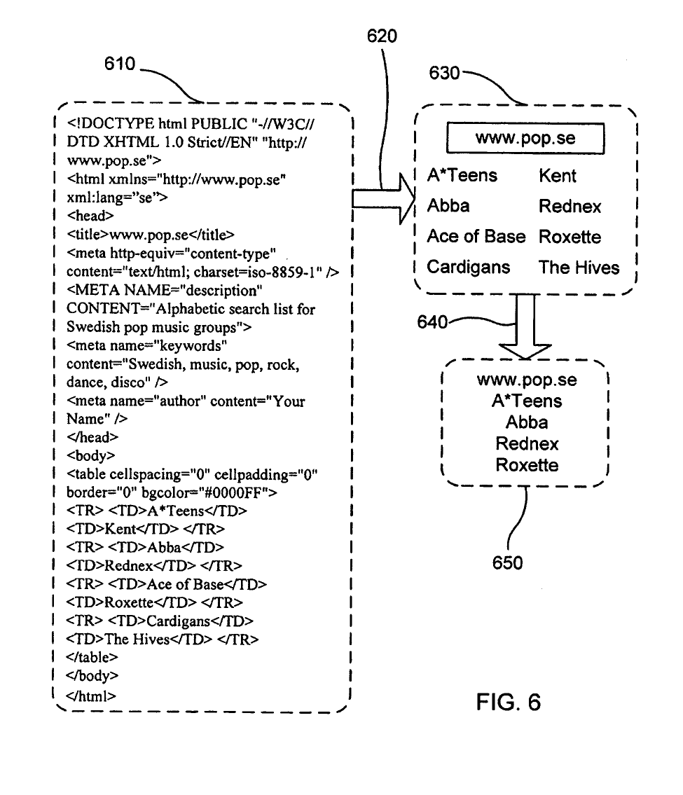

FIG. 6 provides an illustration of different text file formats 610, 630, 650. The file format identified by the reference numeral 610 illustrates typical HTML code. Typically the HTML format comprises a number of so-called tags and formatting commands as well as text components. By using a HTML interpreter the HTML text may be converted, in a step 620, to a display format as illustrated by the text format 630. The text format illustrates a typical display view of the HTML code 610. Thus tags and other formatting commands are not visible to a viewing user. In a step 640 all text components not found in the standard T9™ dictionary are extracted. The extracted text components are illustrated by the reference numeral 650. Typically the extraction procedure comprises identifying HTML tags and formatting commands. Typically the extraction procedure further comprises separating the text components from the HTML tags and formatting commands. Typically the extraction procedure further comprises comparing the text components with text components in a dictionary. Typically, text components not found in the dictionary are stored. In the illustrative example of FIG. 6 the text components “ace”, “of”, “base”, “cardigans”, “kent”, “the”, “hives” may be found in a standard T9™ dictionary. Thus, advantageously only the text components “www.pop.se”, “A*Teens”, “Abba”, “Rednex” and “Roxette” may be stored.

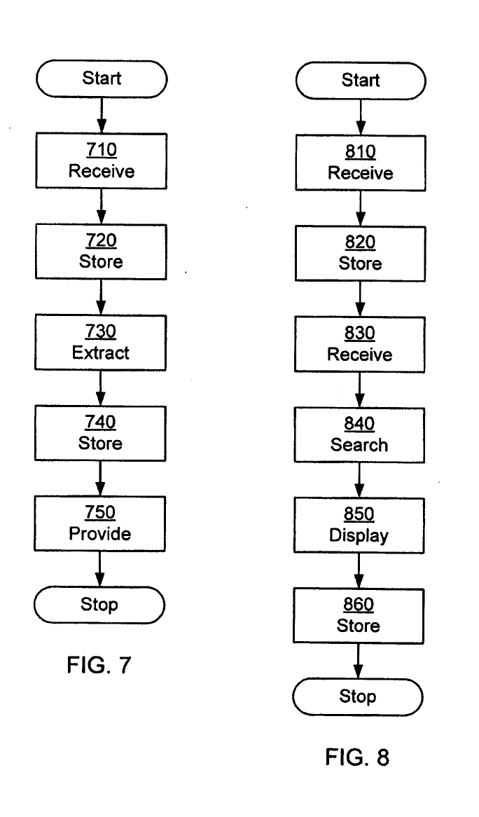

FIG. 7 is a flowchart for a method in a mobile communications device, such as the mobile communications device disclosed in connection with the description of FIGS. 1-5. The method comprises receiving, in a step 710, metadata in a first format, wherein said metadata is associated with a first application. The metadata may comprise embedded text components and/or embedded image components. In a step 720, the metadata is stored in a first memory. Typically the metadata is temporarily stored whilst being browsed by a user. Information components from the stored metadata may then be extracted, in a step 730, to a second format different from the first format using a second application. Typically text components and image components are extracted from the embedded text components and embedded image components, respectively. In a step 740, at least one of the extracted information components are stored in a second memory. Advantageously only those text components not already found in a dictionary for predictive text is stored. The first memory and the second memory may be parts of the same memory. At least one of the at least one of the extracted information components may then be provided, in a step 750, to a third application. The third application may be associated with composing function, such as composing an Email, an SMS, an MMS, a blog item, and the like.

FIG. 8 is a flowchart for a method in a mobile communications device, such as the mobile communications device disclosed in connection with the description of FIGS. 1-5. The method comprises receiving, in a step 810, metadata. The received metadata is then stored, in a step 820, during a predefined first time period. User input defining a first string of characters is then received in a step 830.

The metadata is then searched, in a step 840, for the first string of characters by traversing the received metadata and extracting at least one second string of characters, wherein the at least one second string of characters is embedded in the metadata and a first part of the at least one second string of characters matches said first string of characters. The first string of characters may be associated with an ambiguous text input formed by at least one input key press of a plurality of input keys, wherein each input key of the plurality of input keys is associated with a plurality of input characters. The matching process may then comprise comparing character combinations associated with the ambiguous text input with the first part of the at least one second string of characters. The metadata may comprise at least one image and the at least one second string of characters may be embedded in the at least one image.

The method further comprises displaying, in a step 850, the at least one second string of characters for selection. In a case one of the at least one second string of characters is selected, in a step 860 the at least one second string of characters is stored in a first predictive text dictionary. The method may further comprise searching a second predictive text dictionary for the first string of characters.

The method may further comprise displaying the metadata and in a case a first part of the at least one second string of characters matches the first string of characters, the first string of characters in the metadata may be highlighted. The metadata may be displayed e.g. if the metadata is associated with a webpage.

In a case a first part of at least one third string of characters matches the first string of characters, the at least one second string of characters and the at least one third string of characters may be displayed for selection. The at least one third string of characters may be comprised in the second predictive text dictionary.

The method may further comprise searching the metadata for the first string of characters only in a case the first string of characters is not found in the second predictive text dictionary.

The method may further comprise extracting all unique strings of characters in the metadata. Only those unique strings of characters which are not comprised in the second predictive text dictionary may then be stored. The received metadata may be stored during a first time period; and the unique strings of characters may be stored during a second time period. The second time period may be longer than the first time period.

A unique string of characters is here defined as a string of characters not previously associated with a dictionary for predictive text. That is, if the dictionary comprises the string of characters X1 . . . Xi but not the string of characters X1 . . . Xj, wherein the character Xj is not the space character, and further wherein the character Xi is different from the character Xj, the string of characters X1 . . . Xj may be defined to be a unique string of characters. For example, if the dictionary comprises the string of characters “a”, “ab” and “abb”, but not the sequence of characters “abba” the sequence of characters “abba” may be defined to be unique. For example, if the dictionary comprises the string of characters “h”, “he” and “hel”, but not the sequence of characters “hej” the sequence of characters “hej” may be defined to be unique.

The invention has mainly been described above with reference to a certain examples. However, as is readily appreciated by a person skilled in the art, other examples than the ones disclosed above are equally possible within the scope of the invention, as defined by the appended patent claims.

1. A mobile communications device, comprising:
a receiver for receiving metadata;
a memory for storing said received metadata;
a user interface for receiving user input defining a first string of characters;
a controller for searching said metadata for said first string of characters by traversing said received metadata and extracting at least one second string of characters, wherein said at least one second string of characters is embedded in said metadata and wherein a first part of said at least one second string of characters matches said first string of characters; wherein
said user interface is arranged to display said at least one second string of characters for selection; and wherein
said controller is arranged to instruct said memory to, in a case one of said at least one second string is selected, store said at least one second string in a first predictive text dictionary.

2. The mobile communications device according to claim 1, wherein
said user interface when in operation is arranged to display said metadata; and
said controller is arranged to instruct said user interface to, in a case a first part of said at least one second string of characters matches said first string of characters, highlight said first string of characters in said metadata on said user interface.

3. The mobile communications device according to claim 1, wherein
said memory further comprises a second predictive text dictionary; and
said controller is arranged for searching said second predictive text dictionary for said first string of characters.

4. The mobile communications device according to claim 3, wherein
said controller is arranged to instruct said user interface to, in a case a first part of at least one third string of characters matches said first string of characters, display said at least one second string of characters and said at least one third string of characters for selection, wherein said at least one third string of characters is comprised in said second predictive text dictionary.

5. The mobile communications device according to claim 3, wherein
said controller searches said metadata for said first string of characters only in a case said first string of characters is not found in said second predictive text dictionary.

6. The mobile communications device according to claim 3, wherein
said controller is arranged to extract all unique strings of characters in said metadata and to instruct said memory to store in said first predictive text dictionary only those unique strings of characters which are not comprised in said second predictive text dictionary.

7. The mobile communications device according to claim 6, wherein
said memory stores said received metadata during a first time period; and
said memory stores said unique strings of characters during a second time period.

8. The mobile communications device according to claim 7, wherein
said second time period is longer than said first time period.

9. The mobile communications device according to claim 1, wherein
said user interface comprises a web browser arranged to display a webpage and wherein said metadata is comprised in said webpage.

10. The mobile communications device according to claim 1, wherein
said metadata comprises at least one image and wherein said at least one second string of characters is embedded in said at least one image.

11. The mobile communications device according to claim 1, wherein
said user interface comprises a plurality of input keys, wherein each input key of said plurality of input keys is associated with a plurality of input characters;
said first string of characters is associated with an ambiguous text input formed by at least one input key press of said plurality of input keys; and
said matching comprises comparing character combinations associated with said ambiguous text input with said first part of said at least one second string of characters.

12. In a mobile communications device, a method comprising:
receiving metadata;
storing said received metadata;
receiving user input defining a first string of characters;
searching said metadata for said first string of characters by traversing said received metadata and extracting at least one second string of characters, wherein said at least one second string of characters is embedded in said metadata and a first part of said at least one second string of characters matches said first string of characters;
displaying said at least one second string of characters for selection; and wherein
in a case one of said at least one second string of characters is selected, storing said at least one second string of characters in a first predictive text dictionary.

13. The method according to claim 12, further comprising:
displaying said metadata; and wherein
in a case a first part of said at least one second string of characters matches said first string of characters, highlighting said first string of characters in said metadata.

14. The method according to claim 12, further comprising:
searching a second predictive text dictionary for said first string of characters.

15. The method according to claim 14, wherein
in a case a first part of at least one third string of characters matches said first string of characters, displaying said at least one second string of characters and said at least one third string of characters for selection, wherein said at least one third string of characters is comprised in said second predictive text dictionary.

16. The method according to claim 14, further comprising:
searching said metadata for said first string of characters only in a case said first string of characters is not found in said second predictive text dictionary.

17. The method according to claim 14, further comprising:
extracting all unique strings of characters in said metadata;
storing only those unique strings of characters which are not comprised in said second predictive text dictionary.

18. The method according to claim 17, wherein
said received metadata is stored during a first time period; and
said unique strings of characters is stored during a second time period.

19. The method according to claim 18, wherein
said second time period is longer than said first time period.

20. The method according to claim 12, further comprising:
displaying a webpage and wherein said metadata is comprised in said webpage.

21. The method according to claim 12, wherein
said metadata comprises at least one image and wherein said at least one second string of characters is embedded in said at least one image.

22. The method according to claim 12, wherein
said first string of characters is associated with an ambiguous text input formed by at least one input key press of a plurality of input keys, wherein each input key of said plurality of input keys is associated with a plurality of input characters; and
said matching comprises comparing character combinations associated with said ambiguous text input with said first part of said at least one second string of characters.

23. A computer program stored on a computer-readable storage medium, which when executed on a processor of a mobile communications device performs the method according to claim 12.

24. A user interface of a mobile communications device, wherein said user interface is configured to
displaying metadata;
receiving user input defining a first string of characters;
receiving at least one second string of characters, wherein said second string of characters is embedded in said metadata;
receiving instructions to, in a case a first part of said at least one second string of characters matches said first string of characters, highlight said first string of characters in said metadata on said display;
displaying said at least one second string of characters for selection;
receiving user input pertaining to selecting one of said at least one second string of characters; and
communicating said selecting of said selected one of said at least one second string of characters to a controller.

25. The user interface according to claim 24, wherein
said first string of characters is associated with an ambiguous text input formed by at least one input key press of a plurality of input keys, wherein each input key of said plurality of input keys is associated with a plurality of input characters; and
said matching comprises comparing character combinations associated with said ambiguous text input with said first part of said at least one second string of characters.

26. The user interface according to claim 24, wherein
said user interface is configured to display a webpage; and wherein
said metadata is comprised in said webpage.

27. The user interface according to claim 24, wherein
said metadata comprises at least one image and wherein said at least one second string of characters is embedded in said at least one image.

28. A mobile communications device, comprising:
a receiver for receiving metadata in a first format, wherein said metadata is associated with a first application;
a first memory for storing said metadata;
a controller using a second application for extracting information components from said stored metadata to a second format different from said first format;
a second memory for storing at least one of said extracted information components; and wherein
said controller is configured for providing at least one of said at least one of said extracted information components to a third application.

29. The mobile communications device according to claim 28, wherein
said third application is different from said first application.

30. The mobile communications device according to claim 28, wherein
said first application comprises displaying a webpage;
said information components are text components; and wherein
said third application is associated with text input.

31. The mobile communications device according to claim 28, wherein
said metadata is stored in said first memory during a first time period;
said at least one of said extracted information components is stored in said second memory during a second time period; and wherein
said second time period is longer than said first time period.

32. In a mobile communications device, a method comprising:
receiving metadata in a first format, wherein said metadata is associated with a first application;
storing said metadata in a first memory;
extracting information components from said stored metadata to a second format different from said first format using a second application;
storing at least one of said extracted information components in a second memory; and
providing at least one of said at least one of said extracted information components to a third application.

33. A computer program stored on a computer-readable storage medium, which when executed on a processor of a mobile communications device performs the method according to claim 32.
